(19) United States
(12) Patent Application Publication
(10) Pub. No.: US 2011/0306325 A1
(43) Pub. Date: Dec. 15, 2011

(54) STREAMING VIDEO/AUDIO FROM MOBILE PHONE TO ANY DEVICE

(76) Inventors: Rajesh Gutta, Bangalore (IN); Viraj Thombre, Bangalore (IN)

(21) Appl. No.: 13/150,562

(22) Filed: Jun. 1, 2011

Related U.S. Application Data
(60) Provisional application No. 61/353,544, filed on Jun. 10, 2010.

(51) Int. Cl. H04M 3/42; G06F 3/048

(52) U.S. Cl. 455/414.1; 715/764

(57) ABSTRACT

The present example provides a mobile device such as a phone that can be used for data capturing at remote places and sending the captured data to PC's mobile devices by live streaming using a network such as a WIFI network, the internet, Bluetooth, a CDMA network or any equivalent network. Prior to streaming the signal may be packetized and compressed.

### RELATED APPLICATIONS

This application claims the benefit of U.S. Provisional Application 61/353,544, filed Jun. 10, 2010, which is hereby incorporated by reference

### TECHNICAL FIELD

This description relates generally to applicable to all mobile communications devices in the world independent of the system or network the device operates on, and in particular to mobile telephones having cameras.

### BACKGROUND

Currently mobile phones may support video recording, playing recorded video or transferring recorded video from one mobile to other. However, the functionality for transferring live video through mobile phone is not provided.

### SUMMARY

The following presents a simplified summary of the disclosure in order to provide a basic understanding to the reader. This summary is not an extensive overview of the disclosure, and it does not identify key/critical elements of the invention or delineate the scope of the invention. Its sole purpose is to present some concepts disclosed herein in a simplified form as a prelude to the more detailed description that is presented later.

Currently live streaming media of video is not provided from mobile devices such as mobile phones. Thus a mobile device that provides live streaming of audio and video may be useful. The present example provides a mobile device such as a phone that can be used for data capturing at remote places and sending the captured data to PC's mobile devices by live streaming using a network such as a WIFI network, the internet, Bluetooth, a CDMA network or any equivalent network. Prior to streaming the signal may be packetized and compressed. The examples provided may provide entertainment, and can also provide services in defense and security applications.

Many of the attendant features will be more readily appreciated, as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 is a block diagram showing downloading of recorded media information captured in the past with a mobile device to a PC via a hard-wired cable connection.

FIG. 2 is a block diagram showing downloading of live streaming media information captured in real time with a mobile device to a PC via a wireless network connection.

FIG. 3 is a block diagram showing downloading of live streaming media information captured in real time with a mobile device to another mobile device via a wireless network connection.

FIG. 4 is a flow diagram showing a process for the real time transfer of streaming media from a mobile device.

FIG. 5 is an exemplary network in which streaming video/audio from a mobile device such as a mobile phone to another device may be implemented.

FIG. 6 illustrates an exemplary computing environment in which streaming video/audio from a mobile device such as a mobile phone to another device described in this application may be implemented.

FIG. 7 is a block diagram of a mobile device in which streaming video/audio from a mobile device such as a mobile phone to another device may be provided.

FIG. 8 shows an exemplary layered programming structure (“stack”) that can be utilized in providing networking capabilities to transmit live videos from a mobile device.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

The present example can be useful as a value added feature/service that will provide extensive services in areas like defense, journalism and the like. Such a value added service is designed to be a sensation in new multimedia applications; and is contemplated to become a mandatory feature in future mobile phones and devices. The examples described are not restricted to CDMA/GSM networks, but may be applicable to all mobile networks. The examples tend to add negligible increase in mobile phone or device cost, as the examples tend not to demand hardware or network changes/requirements, in which software applications embodying the process tend to be sufficient for implementation. As described requirement of new protocol stacks are not needed to provide implementation of the process, as packetization and encryption may be directed to be performed by existing stack architectures. In addition, the examples contemplated do not necessitate mobile-to-mobile communication; streaming video sent by mobile can be received though laptop or other similar device.

The examples below describe a CDMA/GSM/Internet/WIFI/Bluetooth or other network that allow live video transferring from a mobile phone to laptop or other mobile phone or device. Using a mobile phone live video can be transferred from remote areas where the mobile device is located to virtually anywhere another mobile device is functioning, or that is accessible to the internet.

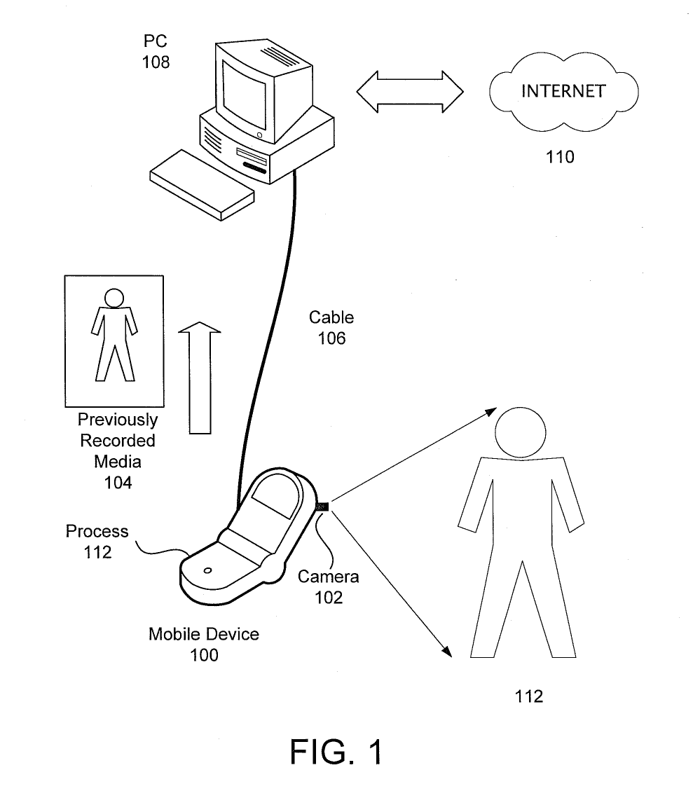

FIG. 1 is a block diagram showing downloading of recorded media information captured in the past with a mobile device to a PC via a hard-wired cable connection. In this arrangement, a user may take one or more single pictures of a subject 112 with a mobile device or cell phone, 100 equipped with a camera 102. The image is recorded and stored in the phone 100. At some point in the future, perhaps when the memory card is full, the user couples the mobile device 100 to a PC 108 via a cable 106. When the user is before his computer 108, the user may download the picture at a later time removed from when the picture was taken, and may then send it over the internet 110.

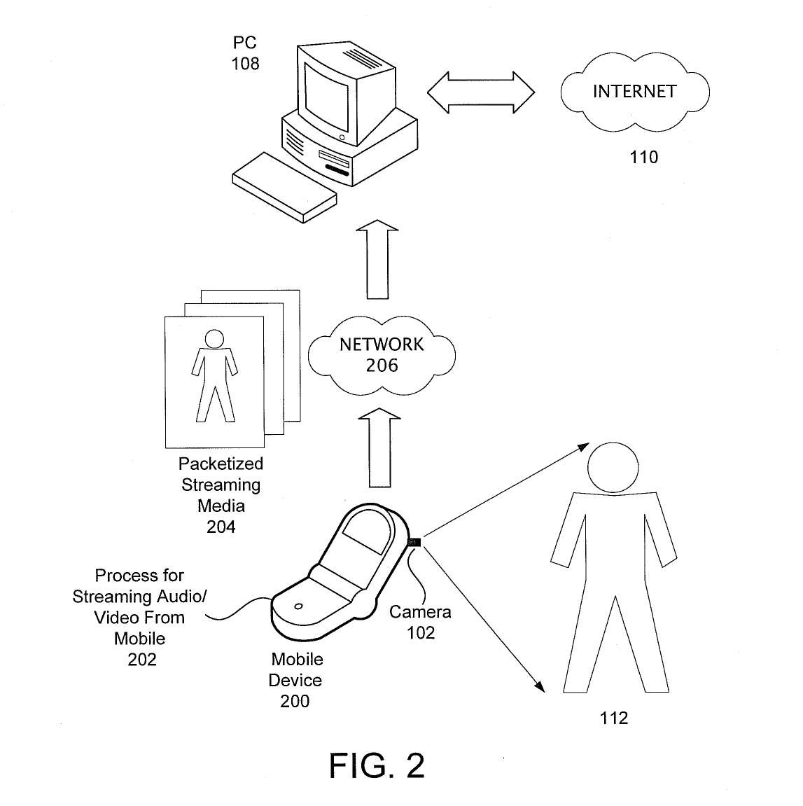

FIG. 2 is a block diagram showing downloading of live streaming media information 204 captured in real time with a mobile device 200 to a PC 108 via a wireless network connection 206, so that live video and/or audio may be sent from a mobile device such as an exemplary cell phone. A video camera 102 on a cell phone may be used to capture a video and or audio transmission of a subject 112. The mobile device 200 may include a process 202 for instantaneously, or for all practical purposes being instantaneous, transmitting the captured audio and video to a remote user. The process 202 typically takes the video and or audio signal from the camera (or equivalently video camera), packetizes, compresses it, and then sends it to a remote user through a PC 108 coupled to the internet 110 as a live streaming media signal 204. Transmission from the mobile device 200 to the PC 108 may be through a wireless network connection 206. The wireless network 206 maybe a Bluetooth network, a 3G network, a 4G network, or the like. The PC 108 includes a suitable application program to receive the live streaming media 204 view the video, and/or record it and/or transmit it over the internet 110 in real time. Thus, a number of users are able to view live images transmitted from a mobile device 200.

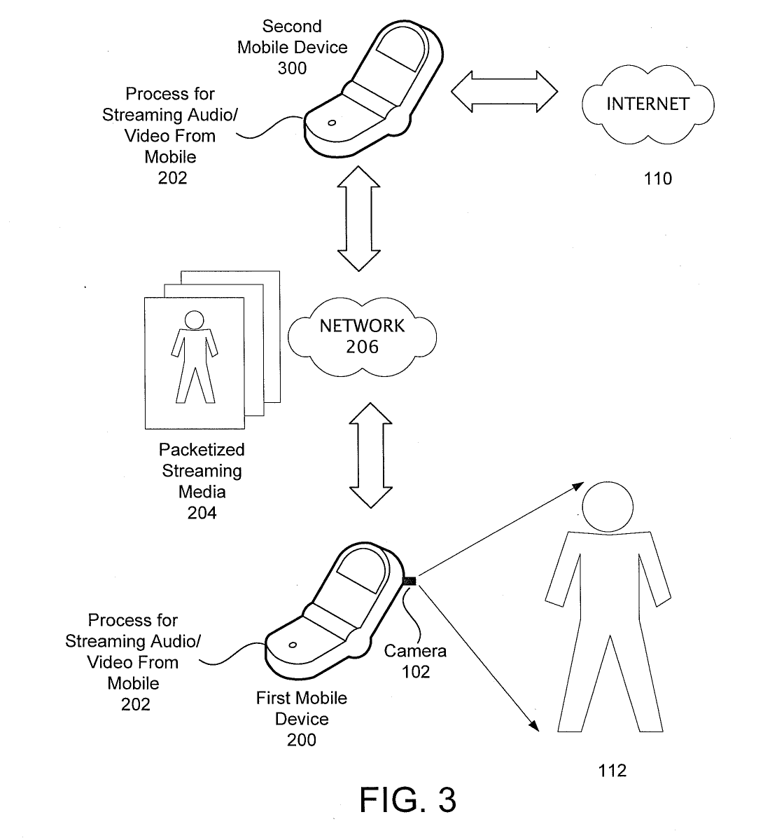

FIG. 3 is a block diagram showing downloading of live streaming media information 204 captured in real time with a first mobile device 200 to a second mobile device 300 via a wireless network connection 206. This may be done so that live video and/or audio may be sent from a first mobile device 200 such as an exemplary cell phone to an exemplary second mobile device 300 such as a second cell phone. A video camera 102 on a cell phone may be used to capture a video and or audio transmission of a subject 112. The mobile device 200 may include a process 202 for instantaneously, or for all practical purposes being instantaneous, transmitting the captured audio and video to a remote user. The process 202 typically takes the video and or audio signal from the camera (or equivalently video camera) 102 and packetizes and compresses it, and then sends it to a remote second mobile device 300, which may be coupled to the internet 110 as a live streaming media signal 204. Transmission from the mobile device 200 to the second mobile device 300 may be through a wireless network connection 206. Wireless network 206 maybe a Bluetooth network, a 3G network, a 4G network or the like. Alternatively, the connection may be provided by the standard voice/data cellular network having sufficient bandwidth. The second mobile device 300 includes a suitable application program to receive the live streaming media 204 and transmit it over the internet 110 in real time. In addition, the first mobile device 200 may also include internet connectivity, so that the signal 204 is streamed from the first mobile device 200 directly to the internet 110, and subsequently to the second mobile device 300, or any number of users who wish to receive the live video and or audio signal 204. Thus, a number of users are able to view live images transmitted from a mobile device 200.

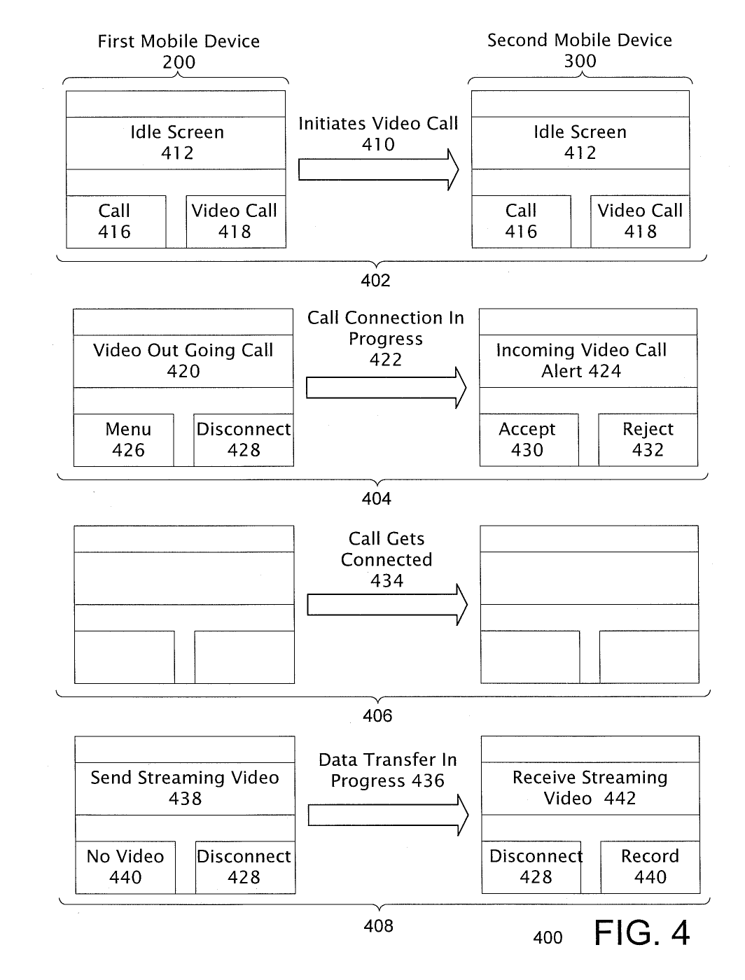

FIG. 4 is a flow diagram showing a process for the real time transfer of streaming media from a mobile device. A mobile device for implementing this process 400 should include a camera, video or media playing capabilities and mobile device or phone should include intelligent software application described below to provide transfer of data from mobile phone, or device. In this process 400 the first mobile device 200 can transfer video to the second mobile device 300. This procedure replicates the transmission of a normal voice call, but with a streaming media signal.

The first stage 402 is to launch video transferring intelligent application in the first mobile device 200 to dial 416 the number of the second mobile device 300. This application will launch a video call with the second mobile device 410. At this stage idle screens 412 may be displayed on one or both mobile devices 200, 300. Indication that a video call originating from a camera is being placed in real time may be provided 418.

At process stage 404 call connection is in progress 422. An outgoing video call may be indicated 420, on the screen of the first device 200. The incoming video call alert 424 may be displayed on the screen of the second mobile device 300. The first mobile device 200 may provide user interface (UI) options to disconnect the call 428, or for more menu options 426. The second mobile device 424 may provide UI options to accept 430 the incoming video call, or to reject 432 the incoming video call.

At process stage 406 the video call is connected 434 between two mobile devices, or phones. Before transmission the data is packetized the data may also be compressed or otherwise subjected to various signal processing in alternative examples. Data containing video information will be transmitted from the first mobile device 200 to the second mobile device 300 in the form of packets. The streaming speed depends on the network in use. For example in an exemplary 3G network, and above (e.g. 4G etc.), network streaming tends to be fast.

In the present example the video data is provided in a low compressive format such as 3gpp, 3gpp2, or equivalent, such that more video content can be transferred with out using excess bandwidth, or alternatively to minimize bandwidth usage. During video transmission, there is feasibility in the second mobile device where live video can be recorded at any time.

At process stage 408, the data transfer is in progress 436. The UI of the first mobile device 200 may provide an indication 438 that the device is sending streaming video, and provide a UI interface to disconnect 428 the live video signal. Once video transfer is completed, call can be disconnected just like normal voice call. At the second mobile device 300, a UI interface may be provided to show that streaming video is received 422. Also provided is a UI to disconnect 428, and to record video 440

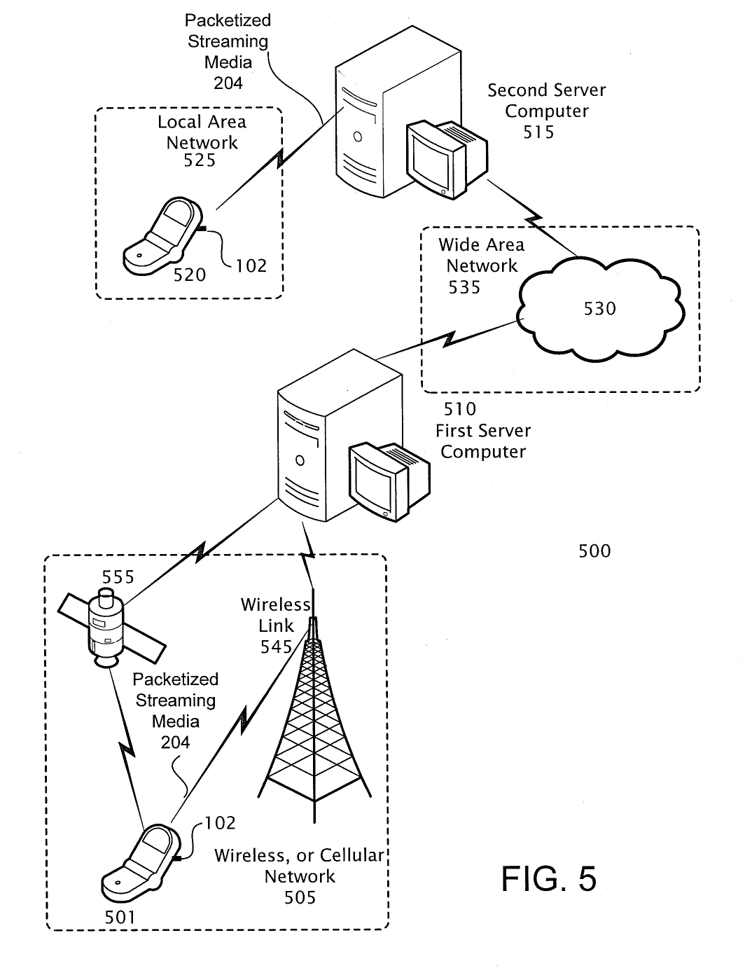

FIG. 5 is an exemplary network 500 in which streaming video/audio from a mobile device such as a mobile phone to another device may be implemented. The networks shown tend to support transmission of live images taken by a camera 102 and transmitted as packetized data 204 through the exemplary network, or its equivalent, shown. Computer 515 may be a server computer coupled to a user's mobile device 520 through a conventionally constructed local area network 525.

In the local area network the users cell phone is typically part of the local area network 525 which may include a plurality conventional computers (not shown) and conventional peripheral equipment (not shown) coupled together as known to those skilled in the art. Those skilled in the art will realize that other processor equipped devices such as televisions and VCRs with electronic program guides, cellular telephones, appliances and the like may be coupled to the internet 535 through such a local area network 525

A typical local area network 525 may include a conventionally constructed ISP network in which a number or plurality of subscribers utilize telephone dial up, ISDN, DSL, cellular telephone, cable modem, or like connections to couple to one or more server computers 515 that provide a connection to the world wide web 535 via the internet 530.

Wide area network or World Wide Web 535 is conventionally constructed and may include the internet 530 or equivalent coupling methods for providing a wide area network. As shown a conventionally constructed first server computer 510 is coupled to conventionally constructed second server computer 515 through a conventionally constructed internet connection to the World Wide Web 530.

In a conventional wireless, or cellular, network 505 a conventionally constructed mobile device 501 is coupled to the internet 530 via a conventionally constructed wireless, or cellular, link 545. The wireless link may include cellular, and satellite technology 555 to provide the link. Such a wireless network may include a conventionally constructed first server computer 510, typically provided to manage connections to a wide area network such as the internet.

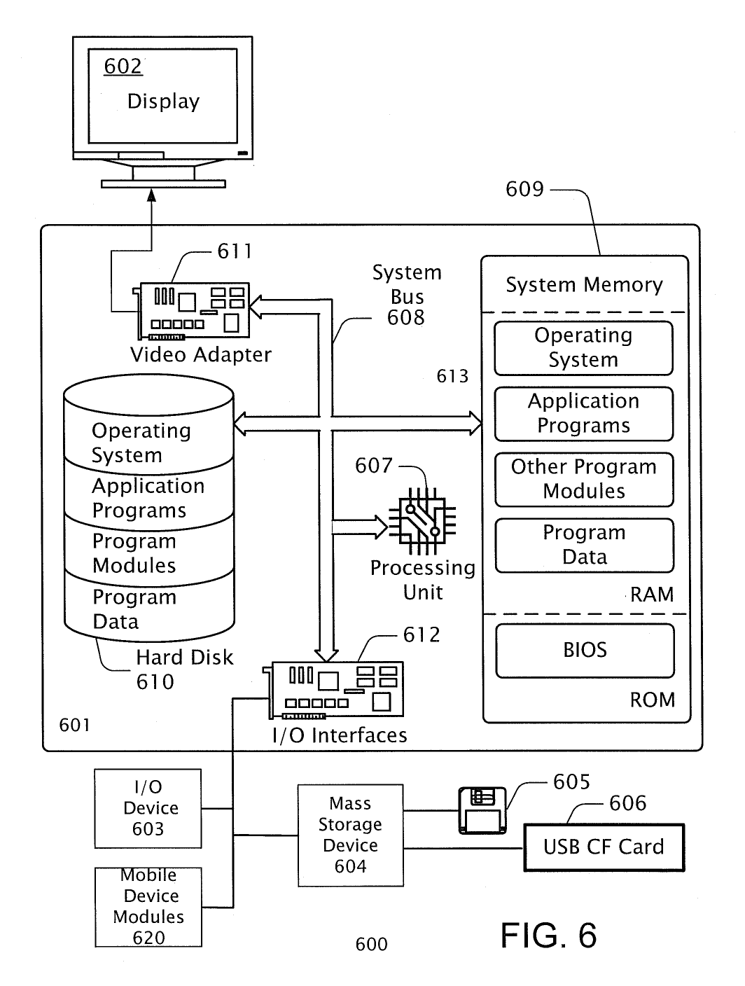

FIG. 6 illustrates an exemplary computing environment 600 in which streaming video/audio from a mobile device such as a mobile phone to another device described in this application, may be implemented. Exemplary computing environment 600 is only one example of a computing system and is not intended to limit the examples described in this application to this particular computing environment.

For example, the computing environment 600 can be implemented with numerous other general purpose or special purpose computing system configurations. Examples of well known computing systems, may include, but are not limited to, personal computers, hand-held or laptop devices, microprocessor-based systems, multiprocessor systems, set top boxes, gaming consoles, consumer electronics, cellular telephones, PDAs, and the like.

The computer 600 includes a general-purpose computing system in the form of a computing device 601. The components of computing device 601 can include one or more processors (including CPUs, GPUs, microprocessors and the like) 607, a system memory 609, and a system bus 608 that couples the various system components. Processor 607 processes various computer executable instructions, including those to ** to control the operation of computing device 601 and to communicate with other electronic and computing devices (not shown). The system bus 608 represents any number of several types of bus structures, including a memory bus or memory controller, a peripheral bus, an accelerated graphics port, and a processor or local bus using any of a variety of bus architectures.

The system memory 609 includes computer-readable media in the form of volatile memory, such as random access memory (RAM), and/or non-volatile memory, such as read only memory (ROM). A basic input/output system (BIOS) is stored in ROM. RAM typically contains data and/or program modules that are immediately accessible to and/or presently operated on by one or more of the processors 607.

Mass storage devices 604 may be coupled to the computing device 601 or incorporated into the computing device by coupling to the buss. Such mass storage devices 604 may include a magnetic disk drive which reads from and writes to a removable, non volatile magnetic disk (e.g., a “floppy disk”) 605, or a removable, USB flash drive, compact flash (CF) card, SIM card or the or the like 606. Computer readable media 605, 606 typically embody computer readable instructions, data structures, program modules and the like supplied on floppy disks, CDs, portable memory sticks and the like.

Any number of program modules and data can be stored on the hard disk 610, mass storage device 604, ROM and/or RAM 600, including by way of example; an operating system, one or more application programs, other program modules, and program data. Each of such operating system, application programs, other program modules and program data (or some combination thereof) may include an embodiment of the systems and methods described herein.

A display device 602 can be connected to the system bus 608 via an interface, such as a video adapter 611. A user can interface with computing device 601 via any number of different input devices 603 such as a keyboard, pointing device, joystick, game pad, serial port, and/or the like. These and other input devices are connected to the processors 607 via input/output interfaces 612 that are coupled to the system bus 608, but may be connected by other interface and bus structures, such as a parallel port, game port, and/or a universal serial bus (USB).

Mobile device 620 may be coupled to the system bus 608 through an appropriate interface as well. The computing device 601 provides processing and memory functions used in the execution of processes resident therein to control and otherwise allow operation of the mobile device 620.

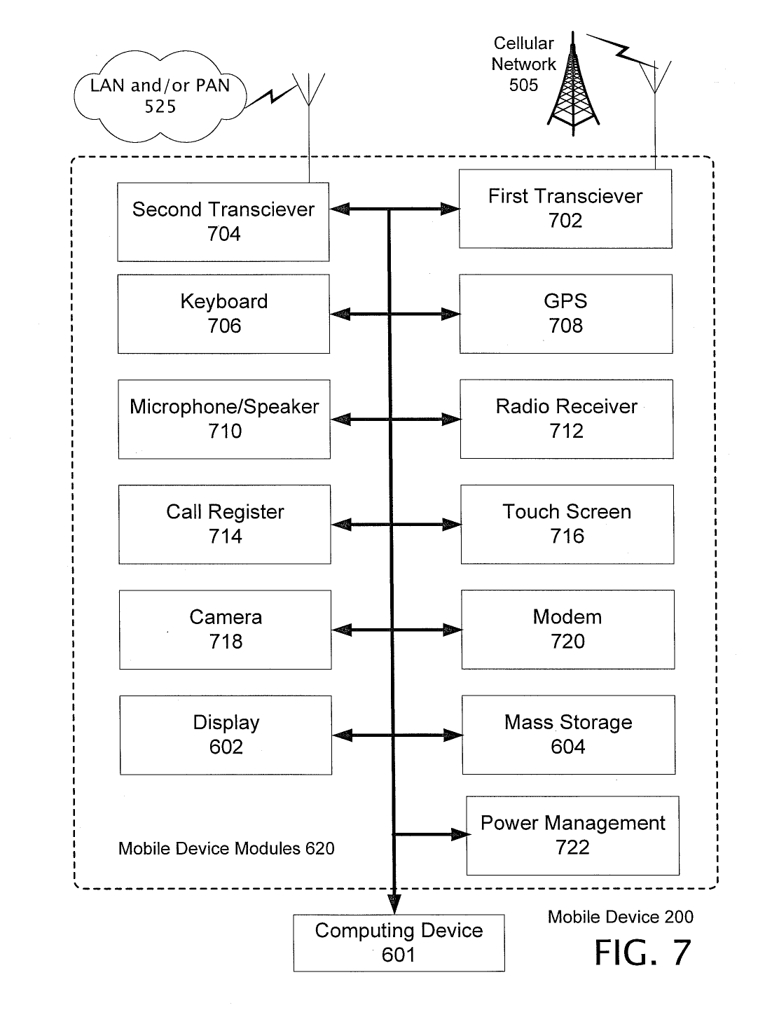

FIG. 7 is a block diagram of mobile device 200 in which streaming video/audio from various mobile devices such as a mobile phone to another mobile device may be provided. A mobile device 200 may include a cell phone, a multifunction communication device with voice and data transmission capabilities (e-mail, SMS text messaging and the like), personal digital assistant (PDA) equipped for wireless communications, a PC having wireless communication capabilities, or the like. A mobile communications device 200 may also be a multi component device such as a PC equipped with a modem card, or the like suitable to enable the PC for mobile communications. In short, a mobile device 200 may include a device having a number of components with wireless connectivity that may include any of the modules 601, 602, 604, 702, 704, 706, 708, 710, 712, 714, 716, 718, 720, 722.

The cell phone example of a mobile device 200 shown can be a conventionally constructed single, dual mode, or multi mode device with a conventionally constructed camera 718. The cell phone may include a processor 601 to control the operation of the cellular telephone 200. The processor 601 controls placing and receiving calls, typically through one or more transceiver modules 702, 704.

A first transceiver module 704 may be coupled to a conventional cellular network 505 such as a global system for mobile communication/general packet radio service (GSM/GPRS) cellular network or the like, typically through an antenna. The first transceiver module 704 may be used for example to place and receive calls, transmit data or the like through a cellular network.

A second transceiver module 702 may couple to an alternative cellular network (not shown), or couple to a wireless network 525 that is either a wide area network (WAN), local area network (LAN), a smaller localized personal area network (PAN), or equivalent. A conventional wireless network such as an 802.11 wireless network may be coupled to for transmission. Alternatively, a Bluetooth connection might be provided to form a PAN for cable replacement of an auxiliary device paired or associated with the mobile device 200 and having a compatible profile. Paired devices may include an exemplary head set, a PC, another mobile device, or another device in which cable replacement with a wireless link is practical. In the present example, live video transfer is possible through another mobile device such as a cellular telephone, a PC or the like.

Exemplary transmission protocols may further include code division multiple access (CDMA), CDMA 2000, universal mobile telecommunications service (UMTS), 802.11 network hot spot technology, or any type of wireless local area network (WLAN) connection technology. In addition appropriate signal compression technologies may be utilized with such transmission protocols to increase the efficiency of the signal being transmitted between paired devices.

Additional components of the mobile device 200 may include a visual display 602 for displaying a user interface (UI), a keyboard 706, a camera 718, microphone/speaker 710, a touch screen 716, power control circuits 722, a GPS 708, a broadcast radio receiver 712, a modem 720, a call register 714 or other exemplary devices. The components, or modules, are typically provided as hardware and software. As will be appreciated by those skilled in the art various hardware functions may alternatively be implemented in software processes.

In further alternative examples Mobile device 200 may also include numerous other components for providing functionalities to a user (not shown). Such additional components may include VoIP connectivity, music (MP3) and video (MP4) playback, alarms, memo and document recording, personal organizers and personal digital assistants, functionalities to watch streaming video or download video for later viewing, built-in video cameras and camcorders (video recording), ringtones, games, memory card reader (SD), SIM card connectivity, USB (2.0) connectivity, infrared connectivity, Bluetooth (2.0) connectivity, Wi-Fi connectivity, instant messaging, e-mail, Internet browsing, functionality allowing the mobile device to serve as a wireless modem for a PC, and functionality to serve as a game console.

Such mobile device modules or components 620 may be coupled to and operate cooperatively with a controller 601, which may include a processor (CPU), memory and other components utilized to run an operating system to control the entire mobile device, or phone 200, to control the flow of voice and/or data to and from the mobile device, and also control auxiliary components that may be included with the mobile device.

Cameras (both still and video) 718 may include a lens, an imager (such as a CCD), and processing circuitry to store an image or images, either compressed or not, typically onto a memory until the image or images can be downloaded to another device at a later time. Software is typically provided to implement a process for controlling the camera. Additional software may also be included for playing back the image or images, on the telephone display. In the example described above the camera is capable of providing audio and/or video signals in real time to a PC, another mobile device, or the like. Such images captured and relayed in real time may thus be communicated in real time over the internet to one or more users.

The camera 718 may be configured to take still photographs or videos. The camera is coupled to a processor 601 and controlled by one or more software application programs that allow such real time streaming of images and audio. The applications may include unique processes for causing images captured to be stored and processed by the mobile device. The exemplary application may include compression and streaming processes to aid in streaming media transmission.

Mass storage 604, may include or work in cooperation with various forms of digital media (604, 609 of FIG. 6) previously described so that images, video, audio, and the like may be stored for later use on the device or later download. Memory may include USB flash drives, compact flash drives, CDs, portable hard disks, and the like. However, because of the examples described above memory may not be needed to store audio and images for downloading at a later time, as such streaming media is transmitted directly to another user or device. Some memory buffering may be appropriate to aid in the transmission and encoding of such real time signals being transmitted.

A subscriber identity module (SIM), or smart card may be included as a mass storage device 604 to identify and personalize a mobile device and the media being streamed. The SIM is coupled to the processor and allows a subscriber access to services, and to store user information such as calendars, address books photos, voice mails and other user-oriented information such as user identity. The SIMM may typically be removed and switched between various mobile devices so the user's information may be made portable between mobile devices.

A computer network, including a cellular data network is typically an interconnection of a group of computers with communications and processing facilitated by computer programming, typically implemented in a layered structure that that includes functions for assembling packets of data for transmission, transmitting the data, and then extracting or reassembling the data. A layered structure can allow for an ordered and logical implementation of computer processes and communications by compartmentalizing related processes, and providing known interfaces between processes. A layered structure is advantageously used in the implementation of a process for the real time transfer of video from a mobile device.

The four-layer Internet Protocol (“IP”) model is an example. The seven-layer Open Systems Interconnection (“OSI”) reference model is another example. A number of networks use the Internet Protocol as their network model; however, the seven layer (Application, Presentation. Session, Transport, Network, Data Link, and Physical Layers) OSI model or the like may be equivalently substituted for the four layer (Application, Transport, Network and Data Link Layers) IP model. In further alternative examples, different layered program structures for networking may be provided that provide equivalent interconnection capabilities.

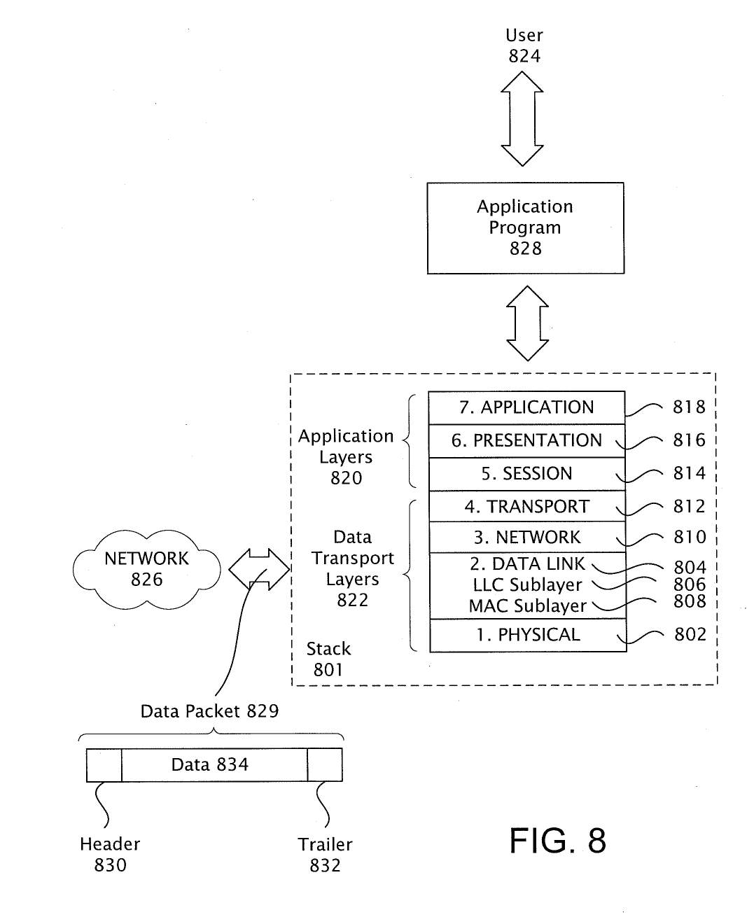

FIG. 8 shows an exemplary layered programming structure (“stack”) 801 that can be utilized in providing networking capabilities to transmit live videos from a mobile device. Application programs such as one to control the live transmission of a video signal 818 typically do not couple directly to a network 826. They may often couple to a network 826 through a layered programming structure 801 that facilitates networking, without placing undue programming burdens on the application program 818. Thus, application program may implement in its coding the functionality described in FIG. 4 and the accompanying description, with encryption and packetization delegated to the stack. Each layer 802, 804, 806, 808, 810, 812, 814, 816, 818 can be written somewhat independently for a particular network implementation which, also tends to simplify providing software networking functions.

Programming 818 that may wish to provide network connectivity 826 can be implemented by providing programming in an exemplary layered structure 801. The exemplary Open Systems Interconnect (“OSI”) model 801 is an exemplary abstract description for communications and computer network protocol design. The OSI model describes how information from a software application 818 in one computer moves through a network medium 826 to a software application in another computer (not shown).

The OSI model 801 divides tasks involved with moving information between networked computers into smaller, more manageable task groups arranged in layers 802, 804, 806, 808, 810, 812, 814, 816, 818. In general, an OSI transport layer 802, 804, 806, 808, 810, 812 is generally capable of communicating with three other OSI layers, the layer directly above it, the layer directly below it, and its peer layer in another computer that it is coupled to. Information being transferred from a software application 818 in one computer system to a software application in another (not shown) must usually pass through the application layers 820 to the transport layers 822 where it may be readied for transport, before actual transfer occurs.

A task or group of tasks can be assigned to each of the OSI layers 802, 804, 806, 808, 810, 812, 814, 816, and 818. Each layer can be set up to be reasonably self-contained so that the tasks assigned to each layer can be implemented independently. Layering also enables the tasks implemented by a particular layer to be updated without adversely affecting the other layers. The exemplary OSI model 801 can be structured in layers that can include an:

1. Application layer 818;

2. Presentation layer 816;

3. Session layer 814;

4. Transport layer 812;

5. Network layer 810;

6. Data Link 804; and a

7. Physical layer 802.

A layer can be a collection of related functions that provide services to the layer above it, and are provided with services from the layer below it. The listed layers and functions are exemplary only. For example, more or fewer layers may be provided, and the functions of the layers may vary depending upon the application.

The application layers 820 may be in communication with an application program 828. To communicate information from, or regarding, the application program 828 the application layer 820 can generate information units 834 that may be passed to one or more of the data transport layers 822 for encapsulation 829 and transfer across the network 826. Each of the three uppermost transport layers 804, 810, 812 can generate its own header 830, trailer 832 and the like to pass information units and data 834 generated from above across the network 826. The lowest transport layer, the physical layer 802 simply transports data from one or more of the higher layers 804, 806, 808, 810, 812, 814, 816, 818 and does not generate its own header, trailer or the like.

1. The Physical layer 802: The physical layer is typically hardware and software, which can enable the signal and binary data transmission (for example cable and connectors). Definition provided by the physical layer can include the layout of pins, voltages, data rates, maximum transmission distances, cable specifications, and the like.

In contrast to the functions of the adjacent data link layer 804, the physical layer 802 primarily deals with the interface of a device with a medium, while the data link layer 804 is concerned more with the interactions of two or more devices with a shared medium.

2. The Data Link layer 804: The Data Link layer 804 is typically software and hardware, which can provide physical addressing for transporting data across a physical network layer 802. Different data link layer specifications that may be implemented in this layer can define different network and protocol characteristics, including physical addressing, network topology, error notification, sequencing of frames, and flow control. Physical addressing in this layer (as opposed to network addressing) can define how devices are addressed from this data link layer 804. Network topology consists of the data link layer specifications that often define how network devices are to be physically connected, such as in a bus topology, ring topology or the like. The data Link layer 804 can provide the functional and procedural means (headers and trailers) to transfer data between network entities, and to detect and possibly correct errors that may occur in the physical layer 802. This layer 804 may be divided into two sub layers 806, 808 if desired:

The Logical Link Control (“LLC”) Sub-layer 806 can refer to the highest data link sub-layer that can manage communications between devices over a single link of a network.

Media Access Control (MAC) sub-layer 808 can refer to the lowest data link sub-layer that can manage protocol access to the physical network medium 826. It determines who is allowed to access the medium at any one time.

3. The network layer 810 can provide path determination and logical addressing. The network layer 810 may define the network address (different from the MAC address). Some network layer protocols, such as the exemplary Internet Protocol (IP) or the like, define network addresses in a way that route selection can be determined. Because this layer 810 defines the logical network layout, routers can use this layer to determine how to forward packets.

The network layer 810 can provide the functional and procedural means of transferring variable length data sequences from a source to a destination while maintaining the quality of service requested by the transport layer 812 immediately above. The network layer 810 performs network routing functions, and might also perform fragmentation and reassembly of data, and report data delivery errors. Routers can operate at this layer 810, by sending data throughout the extended network and making the Internet possible.

4. The transport layer 812 can provide transparent transfer of data between end users, providing reliable data transfer services to the upper layers. The transport layer 812 accepts data from the session layer 814 above and segments the data for transport across the network 826. In general, the transport layer 812 may be responsible for making sure that the data can be delivered error-free and in proper sequence. Exemplary transport protocols that may be used on the internet can include TCP, UDP or the like.

5. The session layer 814 can provide Inter-host communication. The session layer 814 may control the dialogues/connections (sessions) between computers. It establishes, manages and terminates the connections between the local 818 and remote application (not shown). It provides for full-duplex, half-duplex, or simplex operation, and can establish check-pointing, adjournment, termination, restart procedures and the like. Multiplexing by this layer 814 can enable data from several applications to be transmitted via a single physical link 826.

6. The presentation layer 816 can provide functions including data representation and encryption. The presentation layer 816 can establish a context between application layer entities, in which the higher-layers can have applied different syntax and semantics, as long as the presentation service being provided understands both, and the mapping between them. The presentation service data units are then encapsulated into Session Protocol Data Units, and moved down the stack.

The presentation layer 816 provides a variety of coding and conversion functions that can be applied to data from the application layer 818. These functions ensure that information sent from the application layer of one system would be readable by the application layer of another system. Some examples of presentation layer coding and conversion schemes include QuickTime, Motion Picture Experts Group (MPEG), Graphics Interchange Format (GIF), Joint Photographic Experts Group (JPEG), Tagged Image File Format (TIFF), and the like.

7. The application layer 818 can link network process to application programs. The application layer interfaces directly to and performs common application services for the application processes; it also issues requests to the presentation layer 816 below. Application layer 818 processes can interact with software applications programs that may contain a communications component.

The application layer 818 is the uppermost layer and thus the user and the application layer can interact directly with the software application. Examples of application layer functions include Telnet, File Transfer Protocol (FTP), Simple Mail Transfer Protocol (SMTP), and the like.

The original architecture of the OSI model can be representative of network architectures that may be designed, and it is provided as an example of many possible architectures that the process described herein may be applied to. Newer equivalent IETF and IEEE protocols, as well as newer OSI protocols have been created, and may equivalently be utilized in the examples described herein. Thus, a particular protocol may be designed to fit into other standards having differing numbers of layers (for example the five layer TCP/IP model) and the like.

A process such as that described herein may equivalently implemented in other suitable layers or sub layers as will be appreciated by those skilled in the art. In particular programming within a layer can be very free flowing and unstructured to achieve a particular task, or process such as the real time transmission of video from a mobile device described herein. However, the programming governing relationships between various layers tends be more structured to facilitate between-layer communications by invoking known processes, and protocols.

Not all layers of the OSI model or its equivalent may necessarily be used. For example WAN networks generally function at the lower three layers of the OSI reference model: the physical layer, the data link layer, and the network layer to provided the desired functions of a WAN network.

Those skilled in the art will realize that the process sequences described above may be equivalently performed in any order to achieve a desired result. In addition, sub-processes may typically be omitted as desired without taking away from the overall functionality of the processes described above.

Those skilled in the art will realize that the circuits described above may be implemented in a variety of configurations, such as discrete circuits, integrated circuits, DSPs, and the like.

What is claimed is:

1. A process for transmitting video in real time comprising:
capturing a video signal on a mobile device;
packetizing the video signal; and
transmitting the video signal.

2. The process for transmitting video in real time of claim 1, further comprising compressing the video signal.

3. The process for transmitting video in real time of claim 1, in which compression is performed by an existing protocol stack.

4. The process for transmitting video in real time of claim 2, in which compression is by 3ggp.

5. The process for transmitting video in real time of claim 1, in which the video signal is transmitted to another mobile device.

6. The process for transmitting video in real time of claim 1, in which the video signal is transmitted to a PC.

7. The process for transmitting video in real time of claim 1, in which transmitting is by coupling to a 3G network.

8. The process for transmitting video in real time of claim 1, in which transmitting is done by coupling to a Bluetooth network.

9. The process for transmitting video in real time of claim 1, in which packetizing of the video signal is performed by an existing protocol stack.

10. A process for transmitting live video from a cellular telephone comprising:
capturing a video signal by a camera disposed on the cellular telephone:
initiating a live video call to a mobile device:
connecting the live video call to the mobile device; and
transferring a live video to the mobile device.

11. The process for transmitting live video from a cellular telephone of claim 10, in which transferring further comprises packetizing the live video.

12. The process for transmitting live video from a cellular telephone of claim 11, in which packetizing is caused to be performed by an IP stack

13. The process for transmitting live video from a cellular telephone of claim 11, in which packetizing further comprises compressing the live video.

14. The process for transmitting live video from a cellular telephone of claim 13, in which compressing is caused to be performed by an IP stack.

15. The process for transmitting live video from a cellular telephone of claim 10, in which disconnection of the video signal may be initiated by a user.

16. The process for transmitting live video from a cellular telephone of claim 10, in which connecting is performed through a wireless link.

17. The process for transmitting live video from a cellular telephone of claim 16, in which the wireless link is a g3 link.

18. The process for transmitting live video from a cellular telephone of claim 16, in which the wireless link is a Bluetooth link.

19. A user interface comprising:
an outgoing video call notification displayed on a mobile device screen. and
a sending streaming video notification displayed following the outgoing video call notification on the mobile device screen.

20. The user interface of claim 19, further comprising a notification displayed to manually disconnect the outgoing video call.
